(19) United States
(12) Patent Application Publication
(10) Pub. No.: US 2017/0028232 A1
(43) Pub. Date: Feb. 2, 2017

(54) LIFELINE DEVICE FOR TEMPORARY SCAFFOLD AND LIFELINE SUPPORT DEVICE

(71) Applicant: ICHIJOGUMI, LTD., Takamatsu-shi (JP)

(72) Inventor: Kazuyuki WATANABE, Kagawa (JP)

(73) Assignee: ICHIJOGUMI, LTD, Takamatsu-shi (JP)

(21) Appl. No.: 14/809,893

(22) Filed: Jul. 27, 2015

(51) Int. Cl. A62B 35/00; E04G 5/00

(52) U.S. Cl. CPC A62B 35/0062; E04G 5/001; A62B 35/0068

(57) ABSTRACT

A lifeline support device for being mounted on a scaffold frame having a vertical member and a horizontal arm connected to the vertical member, including a tubular support post base, and a support post securable in the support post base. The support post base has a hook engageable over the horizontal arm, a pipe receiver engageable with the vertical member and a clamp detachably mounted to a lower portion of the tubular support post base for clamping the vertical member, while the support post has a proximal portion fittable into the tubular support post base and a distal portion provided with a ring for receiving a lifeline.

### BACKGROUND OF THE INVENTION

Field of the Invention

The present invention generally relates to a lifeline device that is installed on the uppermost working platform of a temporary scaffold and used to prevent construction workers from falling, and, more particularly, to a lifeline support device for the lifeline device.

Description of Related Art

Various types of temporary scaffolds with different shapes and structures (such as prefabricated scaffold, pipe scaffold and bracket scaffold) are used in construction of buildings and civil engineering structures. Common structural features of these temporary scaffolds are that a scaffold unit is constructed by arranging scaffold frames, each including at least a vertical member and a horizontal arm joined generally perpendicular to each other, at predetermined intervals and placing scaffold boards between adjacent scaffold frames, and that the scaffold units are stacked in multiple layers according to the height of the building as a work object or the progress of construction work to obtain a temporary scaffold with a desired height.

When the scaffold units are stacked in multiple layers, safety measures are taken to prevent the workers from falling by stretching a lifeline tight on the opposite side of the building above the scaffold boards of the current uppermost scaffold unit (the scaffold boards that will be a working platform of the newly added scaffold unit), and having each worker fasten the hook at an end of a hooked lanyard connected to the harness around his waist to the lifeline. The lifeline is stretched tight between lifeline support devices, each of which is secured at its lower part to an upper part of the vertical member of a scaffold frame of the uppermost scaffold unit in an upright position. Conventionally, various types of lifeline devices have been proposed.

For example, a lifeline device disclosed in JP-A-2000-17848 is adapted to be is installed in a prefabricated scaffold. The lifeline device includes two straight-rod like lifeline support devices that are located at two locations a predetermined distance away from each other on the prefabricated scaffold, each of the lifeline support devices being configured to be securely fixed at its lower part to a vertical member of a scaffold frame of the uppermost scaffold unit from one side with its upper part extending upward beyond the ledger of the scaffold frame, and a lifeline that is stretched between the paired right and left lifeline support devices.

However, each of the lifeline support devices of the lifeline device disclosed in JP-A-2000-17848 is a one-piece straight-rod like member and is therefore relatively heavy in weight. Thus, when a worker lifts up the lifeline support devices beyond the ledger of a scaffold frame of the uppermost scaffold unit to fixedly secure it to a vertical member of the scaffold frame from one side, the work is so hard that the working efficiency does not improve.

In addition, each lifeline support device is fixedly secured to a vertical member of a scaffold frame from one side, the lifeline support devices are located outside the outer peripheries of the vertical members of the scaffold frames after the completion of attachment of the lifeline support devices. Thus, when the lifeline is stretched between the paired right and left lifeline support devices, the lifeline is stretched outside the scaffold frames of the newly added scaffold unit. Thus, when a worker works with his lanyard fastened to the lifeline, for example, he can freely move within one span but must release his lanyard from the lifeline and then fasten it to the lifeline again every time he moves across two spans. This reduces the degree of freedom of movement of the workers and result in a decrease in work efficiency.

A lifeline device disclosed in JP-A-2005-188275 is for being installed in a pipe scaffold. The lifeline device includes two preceding handrail poles that are located at two locations a predetermined distance away from each other, each of the preceding handrail poles including a lifeline guide at its distal portion and being configured to be fixedly secured at its lower part to a standard from one side with its upper part extending upward beyond a putlog of the uppermost scaffold unit, and a lifeline that is stretched between the paired right and left preceding handrail poles.

However, each of the preceding handrail poles of the lifeline device disclosed in JP-A-2005-188275 is a one-piece member and is therefore relatively heavy in weight. In addition, the preceding handrail poles and the lifeline stretched therebetween are located outside the standards. Thus, the lifeline device has the same problems as the lifeline device disclosed in JP-A-2000-17848.

### SUMMARY OF THE INVENTION

It is, therefore, an object of the present invention to provide a lifeline support device that is easy to install and convenient to use and can improve working efficiency.

In accordance with a first aspect of the present invention, there is provided a lifeline support device for being mounted on a scaffold frame having a vertical member and a horizontal arm connected to the vertical member, said lifeline support device comprising:

a tubular support post base having an upper portion provided with a hook engageable with the horizontal arm from above and a pipe receiver engageable with the vertical member, such that, when the hook is engaged over the horizontal arm with the pipe receiver engaged with the vertical member, the tubular support post base is held generally parallel to the vertical member,

a clamp mounted to a lower portion of the tubular support post base for clamping the tubular support post base to the vertical member, and

a support post having a proximal portion fittable into and securable by the tubular support post base and a distal portion provided with a ring for receiving a lifeline.

In a second aspect of the present invention, there is provided the lifeline support device of the above first aspect, wherein the proximal portion has an axis that is offset from that of the distal portion so that the orientation of the support post can be changed about an axis of the tubular support post base.

In a third aspect of the present invention, there is provided the lifeline support device according to the above first or second aspect, wherein each of the tubular support post base and the support post of the lifeline support device is formed of a square pipe having two pairs of opposing sides, so that the support post is securable in the tubular support post base in four different orientations relative to the tubular support post base.

In a fourth aspect of the present invention, there is provided the lifeline support device according to the above third aspect, wherein one of the two pairs of the opposing sides that constitute the tubular support post base each have a first pin hole, while each of the four sides that constitute the support post has a second pin hole, said first and second pin holes are located so that when the support post is secured in the tubular support post base, a pin is insertible through the two first pin holes and two second pin holes at the same time, and wherein said pin is secured to the tubular support post base by means of a flexible connecting member.

According to the fifth aspect of the preset invention, there is provided a lifeline device for use in a temporary scaffold constructed by stacking scaffold units in multiple layers, each of the scaffold units being constructed by longitudinally arranging a plurality of scaffold frames at predetermined intervals and placing scaffold boards between adjacent scaffold frames, each of the scaffold frames including a pair of spaced apart vertical members and a horizontal arm between the vertical members, said lifeline device comprising:

a pair of right and left lifeline support devices according to any one of the above first to third aspects,

a lifeline that is configured to be linked to the rings of the paired lifeline support devices, and

a lifeline tensioner that is connectable to the lifeline so that the lifeline, when linked to rings of the paired lifeline support devices mounted on the scaffold unit and spaced apart a predetermined distance, is maintained in a tightly stretched condition between the paired lifeline support devices.

The present invention can provide the following effects. According to the first aspect of the present invention, the lifeline support device has a dividable structure including a tubular support post base and a support post. Thus, when the lifeline support device is mounted on the scaffold frame, the tubular support post base is first attached to the scaffold frame and then the support post is attached to the tubular support post base. Thus, compared to a case where the lifeline support device has a unitary structure, for example, the burden on the workers during the mounting work is reduced so much that the workers can carry out the work safely and appropriately. This also leads to improved reliability of a lifeline device composed of two lifeline support devices of the type described above.

In addition, because the support post is attached to the tubular support post base by fitting the proximal portion of the support post into the tubular support post base, the support post can be attached easily and quickly compared to a case where the support post is secured to the tubular support post base by bolts, for example.

Moreover, according to the first aspect of the invention, the tubular support post base is detachably mounted to the scaffold frame by the hook configured to engage over a peripheral surface of the horizontal arm from above, and the pipe receiver configured to engage with a peripheral surface of the vertical member from sideward. Thus, at the time the lifeline support device is installed on the scaffold frame, the tubular support post base is prevented from falling because of the engagement of the hook over the horizontal arm and from inclining because of the engagement of the pipe receiver with the vertical member. Further, by the engagement between the hook and the horizontal arm and between the pipe receiver and the vertical member, the tubular support base is held upright, namely in parallel to the vertical member. The clamp can be thereafter fixed around the vertical member safely and appropriately to clamp a lower portion of the tubular support post base and the vertical member together. Namely, the tubular support post base can be fixed to the scaffold frame more safely and appropriately.

In addition, the tubular support post base is placed at a joint portion between the vertical member and the horizontal arm of a scaffold frame from a direction generally perpendicular to the vertical member and the horizontal arm. Thus, the workers can carry out the work without hanging their bodies outward over the scaffold frame. Thus, the safety of the work is ensured compared to a case where the workers have to hang their bodies outward over a scaffold frame because the tubular support post base needs to be attached to a scaffold frame from outside, for example.

According to the lifeline support device of the second aspect of the present invention, the following unique effects can be achieved in addition to the effects described above. In this invention, the proximal portion and the distal portion of the support post are offset from each other in a direction perpendicular to an axis of the support post, and the orientation of the support post can be changed about an axis of the tubular support post base. Thus, when the support post is attached to the tubular support post base, the offset direction of the distal portion of the support post with respect to its proximal portion can be arbitrarily changed. Therefore, when a pair of such lifeline support devices are mounted, in a spaced apart fashion from each other, on a scaffold unit which is composed of a plurality of scaffold frames longitudinally arranged along a building line at predetermined intervals with scaffold boards being secured between adjacent scaffold frames, the support posts thereof can be offset toward the inside of the scaffold unit (in the direction towards the building), toward the outside of the scaffold unit (in the direction away from the building) or in the longitudinal direction of the scaffold unit (in the direction parallel to the building line) as needed.

When the support posts of the paired lifeline support devices are offset toward the inside of the temporary scaffold unit (hereinafter referred to as “basic form”), the rings at the distal portions of the support posts are located inside the vertical members of the scaffold frames. Thus, when the lifeline is stretched between the rings, the lifeline extends inside the vertical members. Accordingly, even when one or more vertical members exist in the section in which the lifeline is stretched, the workers can move freely within the section with their lifelines fastened to the lifeline. This facilitates the construction work and leads to improvement of working efficiency. In addition, even when another material extends inside the vertical members, the offset of the support posts helps to avoid interference with the material when the lifeline is stretched. This expands the range in which the lifeline can be stretched and, therefore, the range of application of a lifeline device constituted of the lifeline support device.

When the support posts of the paired lifeline support devices are offset toward the outside of the scaffold unit, the rings at the distal portions of the support posts are located outside the vertical members of the scaffold frames. Thus, when the lifeline is stretched between the rings, the lifeline is stretched outside the vertical members. This is preferred when a large working space is required inside the lifeline, for example.

When the support posts are offset in the longitudinal direction of the temporary scaffold, each support post looks like a straight rod and generally overlaps the vertical member when viewed in the longitudinal direction of the temporary scaffold. Thus, when the lifeline is stretched between the rings at distal portions of the support posts, the flexibility of the lifeline enables the lifeline to be located inside the vertical members. Thus, as in the case with the “basic form,” even when one or more vertical members exist in the section in which the lifeline is stretched, the workers can move freely within the section with their lifelines fastened to the lifeline. This facilitates the construction work and leads to improvement of working efficiency. In addition, because the lifeline is stretched immediately inside the vertical members, a larger space can be provided inside the lifeline than in the case of the “basic form” to improve working efficiency.

When the support post of one of a pair of right and left lifeline support devices is offset toward the inside of the temporary scaffold and the support post of the other is offset in the longitudinal direction of the temporary scaffold, the lifeline is stretched slightly obliquely between the paired rope lifeline support devices as viewed from above. However, the obliquity corresponds to the offset amount of the support post offset toward the inside of the temporary scaffold and does not cause any practical problem.

According to the lifeline support device of the third and fourth aspects of the present invention, the following unique effects can be achieved in addition to the effects described above. In this invention, the tubular support post base and the support post are both formed of a square pipe. Thus, the orientation of the support post in the circumferential direction can be easily determined and maintained by simply fitting the support post into the tubular support post base. This facilitates the positioning of the tubular support post base and leads to cost reduction of the lifeline device compared to a case where dedicated positioning members are required, for example.

According to the lifeline device of the fifth aspect of the present invention, the unique effects as described above can be achieved in erection and dismantlement of the temporary scaffold.

### BRIEF DESCRIPTION OF THE DRAWINGS

Other objects, features and advantages of the present invention will become apparent from the detailed description of the invention which follows, when considered in the light of the accompanying drawings, in which:

FIG. 1 is a front view of a temporary scaffold as a first example to which a lifeline device according to the present invention is applied;

FIG. 2 is a front view of a temporary scaffold as a second example to which the lifeline device according to the present invention is applied;

FIG. 3 is an exploded perspective view illustrating the structure of a lifeline support device as a constituent element of the lifeline device of the present invention;

FIG. 4 is a view seen in the direction of arrows IV-IV in FIG. 3;

FIG. 5 is a view illustrating the options for the mode of attachment of a support post to a tubular support post base of a lifeline support device;

FIG. 6 is a view illustrating a mode of attachment of a support post to a tubular support post base of a lifeline support device;

FIG. 7 is a view seen in the direction of arrows VII-VII in FIG. 6;

FIG. 8 is an explanatory view illustrating a mode of attachment of the lifeline support device to a scaffold frame;

FIG. 9 is an exploded perspective view of an essential part of the tubular support post base illustrating the structure of an upper end part thereof;

FIG. 10 is an explanatory view illustrating the modes of attachment of the lifeline support device to a temporary scaffold constructed using a first type of scaffold frames;

FIG. 11 is an explanatory view illustrating the modes of attachment of the lifeline support device to a temporary scaffold constructed using second type of scaffold frames;

FIG. 12 is an enlarged view of the part of the scaffold frame to which the lifeline support device is attached in FIG. 11;

FIG. 13 is an enlarged view of the part of the scaffold frame to which the lifeline support device is attached in FIG. 12;

FIG. 14 is a plan view illustrating the direction of installation of the lifeline support device at each part of a temporary scaffold constructed using the first type scaffold frames;

FIG. 15 is a plan view illustrating the direction of installation of the lifeline support device at each part of a temporary scaffold constructed using the second type scaffold frames;

FIG. 16 is a perspective view illustrating the mode of attachment of the lifeline support device to a clamp binding type pipe scaffold;

FIG. 17 is a perspective view illustrating the mode of attachment of the lifeline support device to a wedge binding type pipe scaffold; and

FIG. 18 is a perspective view illustrating the mode of attachment of the lifeline support device to a bracket scaffold.

### DETAILED DESCRIPTION OF THE PREFERRED EMBODIMENT OF THE INVENTION

Preferred embodiments of a lifeline device and a lifeline support device thereof according to the present invention will be described below taking a case as an example where they are applied to a prefabricated scaffold.

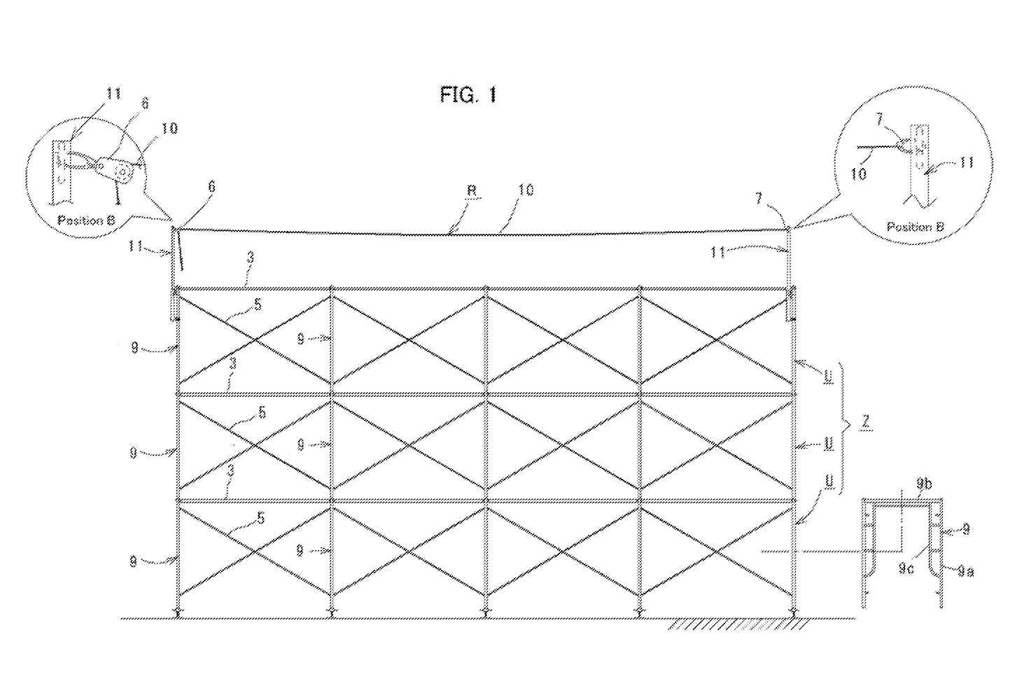

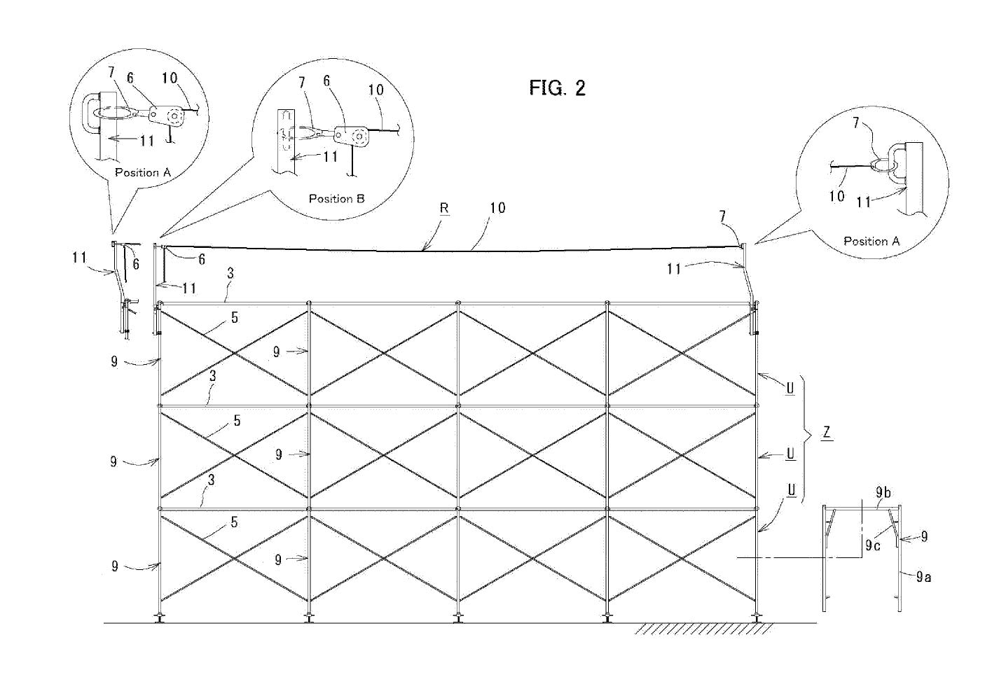

FIG. 1 and FIG. 2 illustrate a state where a lifeline device R according to the present invention is applied to a prefabricated temporary scaffold Z constituted of scaffold frames 9. The temporary scaffold Z shown in FIG. 1 is constructed using inverted U-shaped modular scaffold frames 9 of a reinforced type. As schematically illustrated, as a fragmentary side view, at the lower right corner of FIG. 1, each scaffold frame 9 includes a pair of spaced apart vertical members 9a (such as vertical legs, vertical posts and standards), and a horizontal arm 9b extending normal to the vertical members 9a and connecting the upper ends of the two vertical members 9a to form a generally inverted U-shaped configuration, and ladder-shaped reinforcing members 9c each extending from an intermediate portion to the upper end of a corresponding one of the vertical members 9a.

A temporary scaffold Z shown in FIG. 2 is constructed using inverted U-shaped modular scaffold frames 9 of a simplified type. As schematically illustrated, as a fragmentary side view, at the lower right corner of FIG. 2, each scaffold frame 9 include a pair of spaced apart vertical members 9a, a horizontal arm 9b extending normal to the vertical members 9a and connecting the upper ends of the two vertical members 9a to form a generally inverted U-shaped configuration, and brace-shaped, simplified reinforcing members 9c each provided in the vicinity of the upper end of a corresponding one of the vertical members 9a.

The scaffold frame 9 shown in FIG. 1 and the scaffold frame 9 shown in FIG. 2 are the same in basic structure except the shape and structure of the reinforcing members 9c. It may be, therefore, considered that there is no need to describe them separately, but, in reality, there is a case where the mode of installation of the lifeline device is desired to be changed depending on the shape and structure of the reinforcing members 9c of the scaffold frame 9 as described later. The lifeline support device and lifeline device according to the present invention may be usable for any customarily employed scaffold frame including the above two, reinforced and simplified types. Therefore, except otherwise specifically noted, the term “scaffold frame” as used herein is intended to mean any customarily employed scaffold frame including the above two, reinforced and simplified type ones.

### Construction of Temporary Scaffold Z:

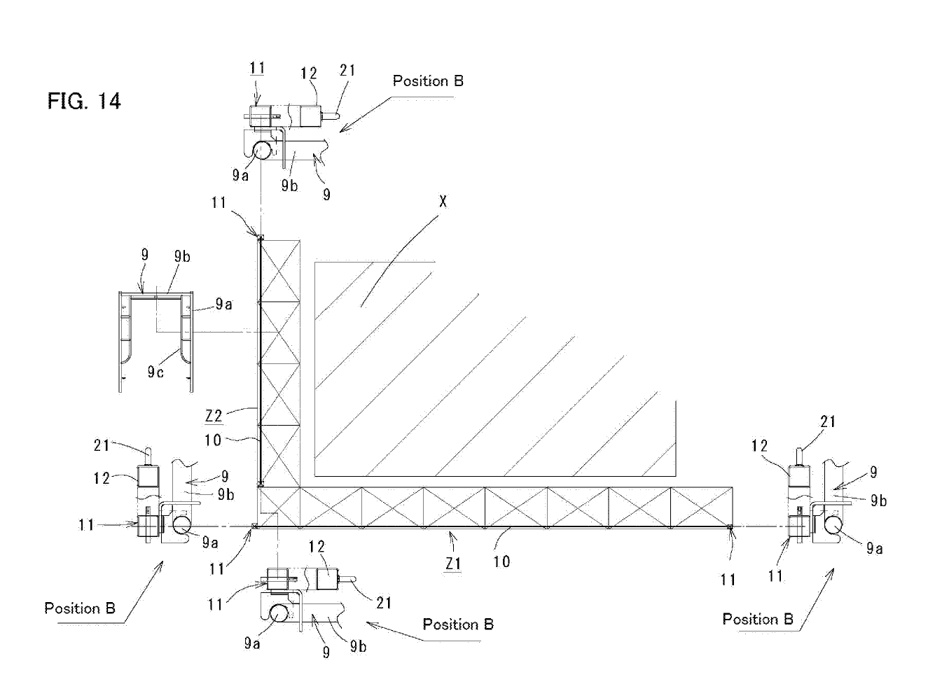

The temporary scaffolds Z shown in FIG. 1 and FIG. 2 are constructed as described below. A plurality of the scaffold frames 9 are longitudinally arranged at predetermined intervals, and adjacent scaffold frames 9 are connected sequentially by X-shaped diagonal struts 5 to integrate the scaffold frames 9 in the direction in which they are arranged. Then, scaffold boards (or platform boards) 3 are attached between the horizontal arms 9b of adjacent scaffold frames 9 to construct a scaffold unit U. Then, such scaffold units U are stacked in multiple layers according to the height of the building X (shown in FIG. 14) as a work object or the progress of the construction work to obtain a temporary scaffold Z with a desired height.

As best seen in FIG. 14, the scaffold frames 9 are arranged in the longitudinal direction with their horizontal arms 9b being oriented in the transverse direction. As used herein, the term “longitudinal direction” is intended to mean “the direction that is horizontal and is parallel to the building line, while the term “transverse direction” is intended to mean “the direction that is horizontal and is perpendicular to the building line”. The “transverse direction” includes a direction towards the building line and a direction away from the building line.

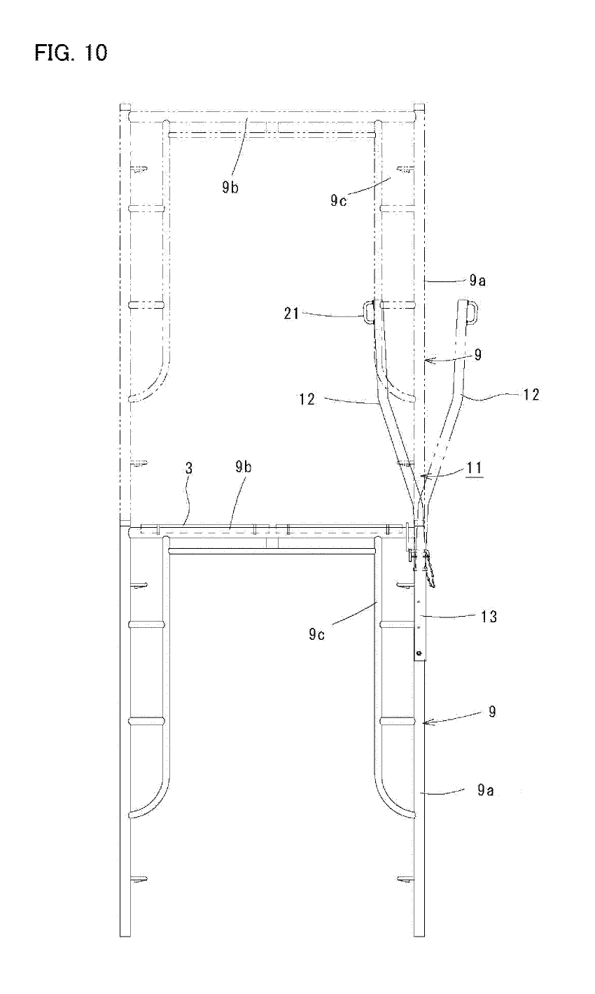

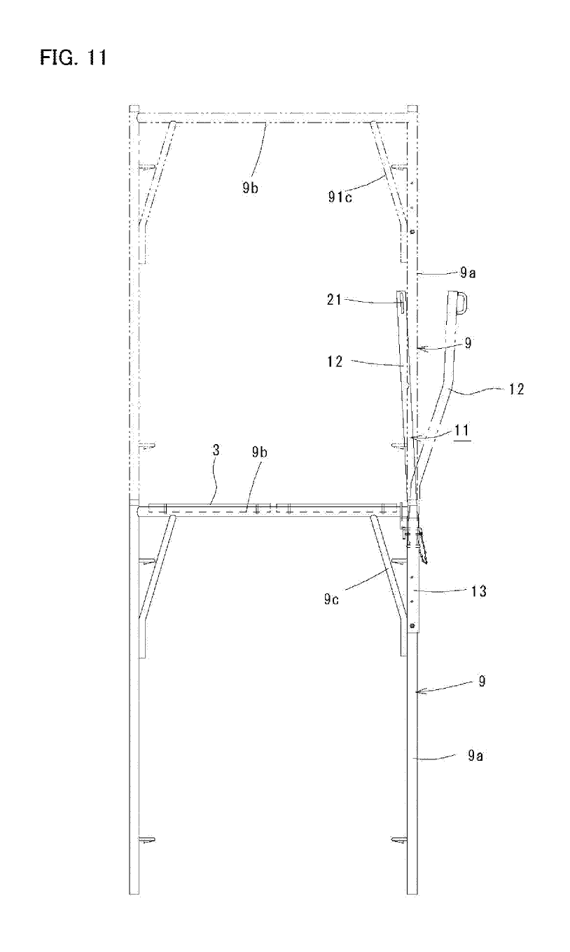

When a new scaffold unit U is constructed on top of an existing scaffold unit U, scaffold boards 3 are installed between the horizontal arms 9b of the scaffold frames 9 of the existing uppermost scaffold unit U as shown in FIG. 1 and FIG. 2. The installation of the scaffold boards 3 for the new scaffold unit U is carried out on the existing uppermost scaffold unit U (on the scaffold boards 3 shown in the solid lines in FIG. 10 and FIG. 11).

Then, the vertical members 9a of a new scaffold frame 9 are connected to the vertical members 9a of each scaffold frame 9 of the existing uppermost scaffold unit U to construct a new scaffold unit U. At this moment, however, no safety measure, such as a handrail, has been provided in the space in which the new scaffold unit U will be constructed (in other words, the space above the scaffold boards 3 forming the ceiling of the existing uppermost scaffold unit U). Thus, the lifeline device R according to the present invention is installed prior to the construction of the new scaffold unit U.

### Lifeline Device R:

FIG. 1 and FIG. 2 illustrate a state of the lifeline device R that has been installed on the existing uppermost scaffold unit U. The lifeline device R includes a pair of right and left lifeline support devices 11 that are respectively attached to upper ends of a pair of right and left scaffold frames 9 spaced a predetermined distance away from each other on the existing uppermost scaffold unit U of the temporary scaffold Z, and a lifeline 10 that is configured to be stretched between the lifeline support devices 11. As best seen in FIG. 14, each of the lifeline support devices 11 is generally installed on one of the paired vertical members 9a of the scaffold frame 9 that is located more remote from the building X.

The lifeline device R shown in FIG. 1 and the lifeline device R shown in FIG. 2 are the same in basic structure but are different in the mode of attachment of the lifeline support devices 11 to the scaffold frames 9 in consideration of the difference in shape of the scaffold frames 9 used to construct the temporary scaffold Z as described above (refer to FIG. 10 and FIG. 11). The lifeline device R usually includes a lifeline tensioner 6 that is used to maintain the lifeline 10 in a tightly stretched condition between the two lifeline support devices 11. The lifeline 10 and lifeline tensioner 6 are well known in the field of scaffold construction. Any suitable customarily employed lifeline and lifeline tensioner may be used for the purpose of the present invention.

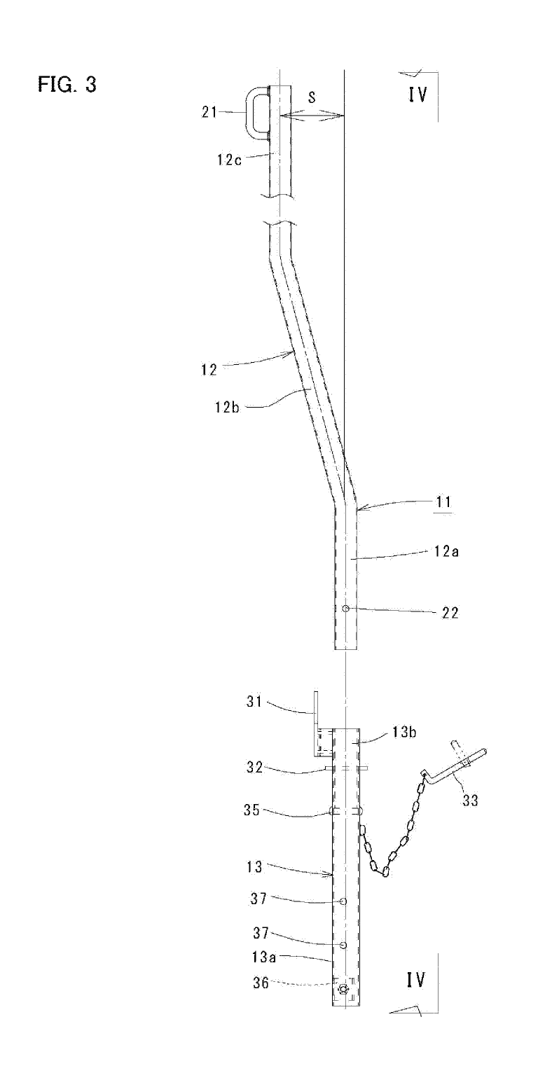

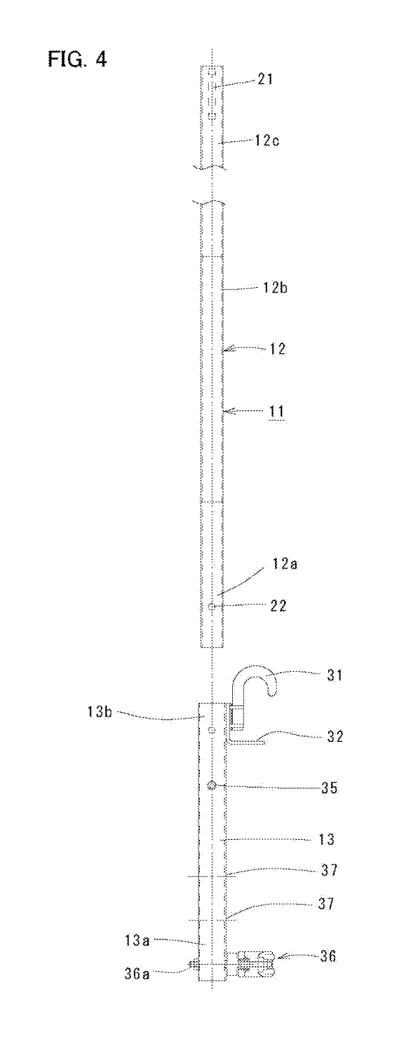

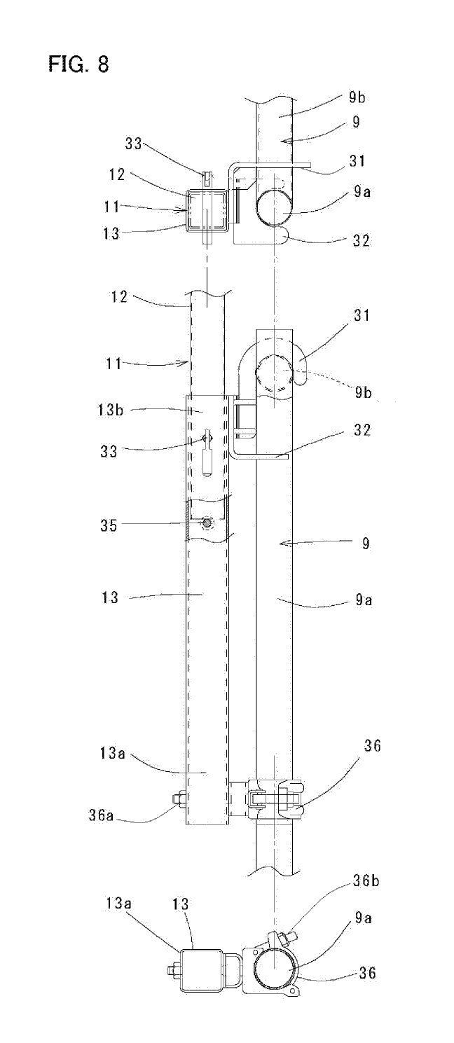

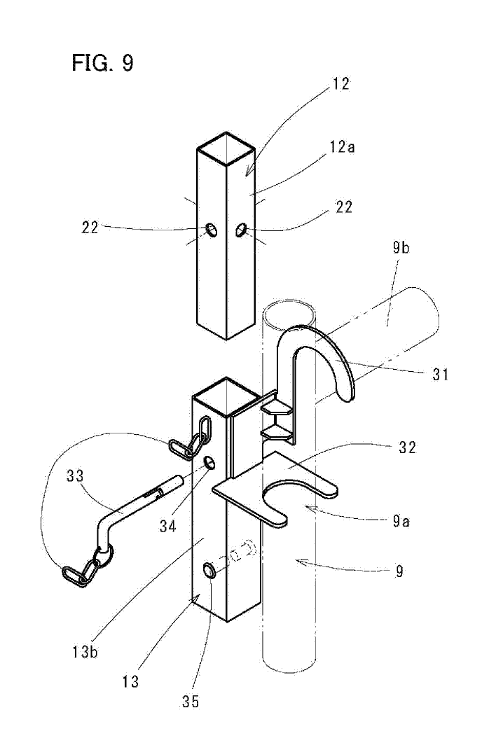

One preferred lifeline support device 11 of the lifeline device R will be described with reference to FIG. 3 and FIG. 4. Reference shall be also made to FIG. 8 and FIG. 9 showing a state of the lifeline support device 11 mounted to a scaffold frame 9 having a vertical member 9a and a horizontal arm 9b connected to the vertical member 9a.

### Tubular Support Post Base 13:

As shown in FIG. 3 and FIG. 4, the lifeline support device 11 includes a tubular support post base 13 and a support post 12 which is releasably insertible or fittable into the tubular support post base 13. As shown in FIG. 3, FIG. 4, FIG. 8 and FIG. 9, the tubular support post base 13 is formed of a square pipe with predetermined dimensions. The tubular support post base 13 has a clamp 36 detachably secured to one side of a lower portion 13a thereof and configured to clamp the vertical member 9a. Namely, when the lifeline support device 11 is mounted on the scaffold frame 9, the clamp 36 can clamp the lower portion 13a of the tubular support post base 13 and the vertical member 9a of the scaffold frame 9 together. The tubular support post base 13 is provided with a suitable number (three in the illustrated case) of bolt holes 37 for use in detachably attaching the clamp 36 thereto with a fastener such as a bolt and nut combination 36a. The bolt holes 37 are spaced apart as appropriate in the axial direction of the tubular support post base 13 so that the position where the clamp 36 is fixed to the vertical member 9a can be changed in the vertical direction by selecting one of the bolt holes 37 as appropriate when the clamp 36 is attached to the tubular support post base 13.

The tubular support post base 13 also has a hook 31 and a pipe receiver 32 attached to one side (the same side as that to which the clamp 36 is attached) of an upper portion 13b thereof. The hook 31 is engageable over a peripheral surface of the horizontal arm 9b of the scaffold frame 9 from above. Upon engagement of the hook 31 with the horizontal arm 9b, the position of the tubular support post base 13 relative to the horizontal arm 9b is determined in the vertical direction (the axial direction of the vertical member 9a) as shown in FIG. 8. The pipe receiver 32 which is positioned at a level lower than the hook 31 has a curved recess engageable with a peripheral surface of the vertical member 9a from a side. Upon engagement of the pipe receiver 32 with the vertical member 9a, the distance between the upper portion 13b of the tubular support post 13 and the vertical member 9a and their relative positions in a horizontal direction are determined as shown in FIG. 9. Namely, the upper portion 13b of the tubular support post 13 is held parallel to and spaced apart from the vertical member 9a.

In addition, the tubular support post base 13 has a pair of first pin holes 34 into which a toggle pin 33 can be detachably inserted. The first pin holes 34 are formed in a pair of opposing walls of the upper portion 13b that are perpendicular to the side to which the hook 31 and the pipe receiver 32 are attached. As best seen in FIG. 9, the toggle pin 33 is connected to one end of a flexible connecting member such as a chain, with the other end of the flexible connecting member being fixed to the tubular support post base 13. A stopper 35 such as a bar is provided in the tubular support post base 13 at a location a predetermined distance away from the first pin hole 34 toward the lower portion 13a. The stopper 35 extends inward in the tubular support post base 13, generally in a diametric direction, so that, when a support post 12, which is described later, is inserted into the tubular support post base 13, the lower end face of the support post 12 is in abutting engagement with the stopper 35 to determine the position of the support post 12 in the vertical direction.

In mounting to the scaffold frame 9, the tubular support post base 13 constituted as described above is placed at a joint portion between the vertical member 9a and the horizontal arm 9b of the scaffold frame 9 from a direction perpendicular to the horizontal arm 9b as shown in FIG. 8 and FIG. 9. First, the hook 31 is engaged over the horizontal arm 9b from above to determine the position of the tubular support post base 13 in the vertical direction (in other words, to prevent the tubular support post base 13 from falling) and the pipe receiver 32 is engaged with the vertical member 9a from a side to maintain the tubular support post base 13 at a predetermined distance from the vertical member 9a. At this moment, the position of the tubular support post base 13 in three directions, i.e. (a) the vertical direction, (b) a horizontal and transverse direction (the axial direction of the horizontal arm 9b) and (c) a horizontal and longitudinal direction (the direction perpendicular to the horizontal arm 9b and the vertical member 9a), with respect to the scaffold frame 9, is determined. Thus, the tubular support post base 13 is reliably prevented from falling accidentally. Then, the worker can secure the lower portion 13a of the tubular support post base 13 to the vertical member 9a with the clamp 36 (for example, by operation of a fastener thereof adapted to grasp and hold the vertical member such as a bolt nut combination as shown in FIG. 8) without need to support the tubular support post base 13 from below. Thus, the worker can carry out the task for mounting the tubular support post base 13 on the scaffold frame 9 easily, safely and adequately. In this way, the attachment of the tubular support post base 13 to the scaffold frame 9 is completed.

### Support Post 12:

Referring still to FIG. 3, FIG. 4, FIG. 8 and FIG. 9, the support post 12 is formed of a square pipe having such a size that it can be fitted into the tubular support post base 13. Thus, each of the tubular support post base 13 and the support post 12 of the lifeline support device 11 is formed of a square pipe having two pairs of opposing sides so that the support post 12 is detachably securable in the tubular support post base 13 in four different orientations relative to the tubular support post base 13. The length of the support post 12 is determined so that the support post 12 can extend upward to a height of approximately 1 m from the upper surfaces of the scaffold boards 3 of the uppermost scaffold unit U when the proximal portion 12a thereof is fitted into the tubular support post base 13 until the proximal portion 12a abuts against the stopper 35.

The support post 12 preferably has a proximal portion 12a and a distal portion 12c that are axially offset in opposite directions from each other by a dimension S as shown in FIG. 3. The offset dimension S of the support post 12 is set based on the shape and dimensions of the reinforcing members 9c of the reinforced scaffold frame 9 and the amount of tilt of the support post 12 determined by the gaps that are formed between the tubular support post base 13 and the support post 12 when the support post 12 is fitted into the tubular support post base 13. The tilt of the support post 12 is described later.

The offset configuration of the support post 12 is not limited to the illustrated configuration (generally S-shaped configuration) formed by an oblique intermediate portion 12b connecting the proximal portion 12a and the distal portion 12c as shown in FIG. 3. What is necessary is that the proximal portion 12a and the distal portion 12c are axially offset from each other by a dimension S, and there is no limitation to the shape of the intermediate portion 12b. For example, the support post 12 may have a generally L-shaped configuration formed by a proximal portion 12a and an intermediate portion 12b extending in line with each other and a distal portion 12c formed by bending an end of the intermediate portion 12b at a generally right angle and extending laterally.

The external dimensions of the support post 12 are determined relatively to the internal dimensions of the tubular support post base 13. Here, there arises a situation where a choice has to be made between two contradictory alternatives because the smaller the gap between the support post 12 and the tubular support post base 13, the less loose and more stable the support post 12 will be in the tubular support post base 13 but the more difficult the fitting of the support post 12 into the tubular support post base 13 will be.

The gap is preferably relatively large as long as the stability of the support post 12 can be ensured when a measure is taken to prevent the lifeline 10 stretched between the distal portions 12c of the support posts 12 from swinging. For example, when commercially available square pipes are used for fabrication of the lifeline support device 11, the tubular support post base 13 may be prepared from a square pipe with side lengths of 50 mm×50 mm and a thickness of about 2.3 mm and the support post 12 may be prepared from a square pipe with side lengths of 40 mm×40 mm and a thickness of about 1.6 mm.

As for the “measure to prevent the lifeline 10 from swinging”, the lifeline 10 may be located close to the vertical members 9a of the scaffold frames 9 from inside the scaffold frames 9 by combining the offset structure of the support posts 12 as described above and the tilt structure of the support posts 12 based on the gaps in order to prevent the lifeline 10 from swinging in this embodiment. This will be described later.

In addition, the support post 12 has a ring 21 for receiving the lifeline 10 on the side of the distal portion 12c toward which the distal portion 12c is offset. The support post 12 has a second pin hole 22 through each of its four walls, in other words, four second pin holes 22 in total, at the proximal portion 12a. The second pin holes 22 formed through the opposite walls of the support post 12 are coaxial so that the toggle pin 33 of the tubular support post base 13 can be inserted through the support post 12. Thus, the second pin holes 22 are formed in such a position that they overlap the first pin holes 34 of the tubular support post base 13 when the proximal portion 12a is fitted into the tubular support post base 13 with the position of the support post 12 determined by the stopper 35. Namely, when the support post 12 is secured in the tubular support post base 13 in position, the toggle pin 33 is insertible through the two opposing first pin holes 34 and two opposing second pin holes 22 at the same time.

### Attachment of Support Post 12 to Tubular Support Post Base 13:

The attachment of the support post 12 to the tubular support post base 13 is achieved by fitting the proximal portion 12a of the support post 12 into the tubular support post base 13 through an opening at the upper end thereof and joining the support post 12 and the tubular support post base 13 with the toggle pin 33. As the support post 12 is formed separately from the tubular support post base 13, they can be attached to the scaffold frame 9 separately. Therefore, the load the worker has to support during the attachment work is smaller and the attachment work is all the simpler and easier than in a case where they are formed integrally.

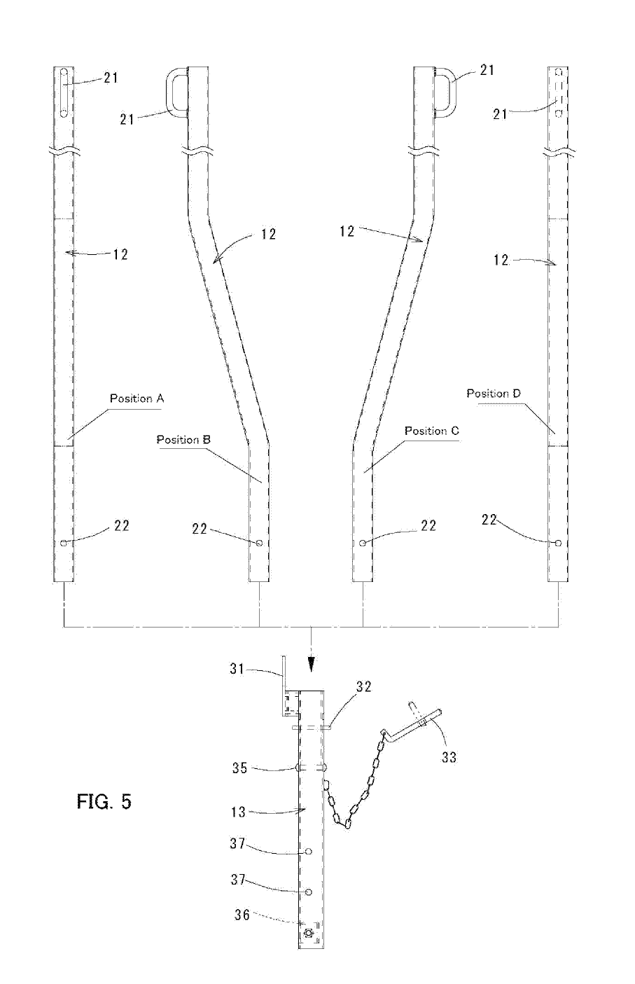

As shown in FIG. 5, when the proximal portion and the distal portion of the support post 12 are axially offset relative to each other, the mode of attachment of the support post 12 to the tubular support post base 13 can be selected from four positions “position A” to “position D.” In the state where the lifeline support device 11 is mounted on the scaffold frame 9 in position, the “position A” and the “position D” are positions in which the support post 12 extends in line with the tubular support post base 13 as viewed in the longitudinal direction (in a direction perpendicular to the horizontal arm 9b), but the extending direction of the ring 21 is opposite between the “position A” and the “position D.” The “position B” and the “position C” are positions in which the distal portion 12c of the support post 12 is offset to one side relative to the tubular support post base 13 as viewed in the longitudinal direction (in a direction perpendicular to the horizontal arm 9b), but the offset direction is opposite between the “position B” and the “position C.”

Thus, when the lifeline device R is actually installed in the temporary scaffold Z, the mode of attachment of each support post 12 may be selected from the four “positions A” to “position D” as desired.

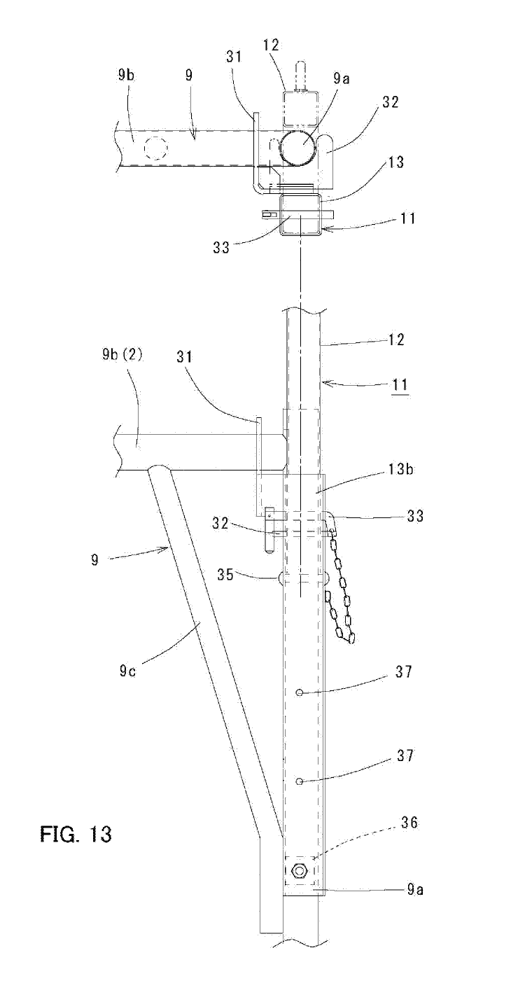

As indicated in the solid lines in FIG. 11 and as shown in FIG. 13, the “position A” and the “position D” are suitable for a temporary scaffold Z constructed using simplified scaffold frames 9, in other words, scaffold frames in which the reinforcing members 9c exist locally at upper corners between the vertical members 9a and the horizontal arm 9b and which have such a structure that the existence of the reinforcing member 9c does not interfere with the installation and use of the lifeline device R. In this case, there is the advantage that a large working space can be obtained inside the lifeline 10 stretched between the rings 21 at the distal portions 12c of the support posts 12.

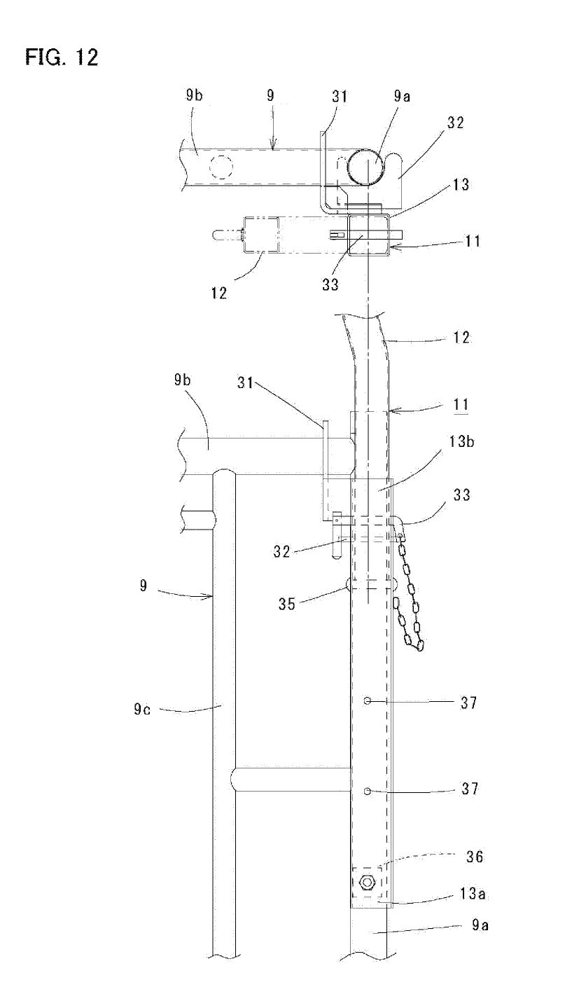

As indicated by solid lines in FIG. 10 and as shown in FIG. 12, the “position B” is suitable for a temporary scaffold Z constructed using the reinforced type scaffold frames 9, in other words, scaffold frames in which a generally ladder-shaped reinforcing member 9c is provided along each vertical member 9a and which have such a structure that the existence of the reinforcing member 9c may interfere with the installation and use of the lifeline device R. In this case, the lifeline 10 stretched between the rings 21 at the distal portions 12c of the support posts 12 can be located inside the reinforcing members 9c to avoid interference therewith. In other words, there is the advantage that, when a worker moves with his lifeline fastened to the lifeline 10, he can move freely along the entire length of the lifeline 10 without the need to release his lifeline from the lifeline 10 and fasten it again thereto. It should be noted that the “position B” is directly applicable to both of a pair of right and left lifeline support devices 11 installed in a temporary scaffold Z as shown in FIG. 14.

The “position C” is applicable to both the reinforced scaffold frame 9 and the simplified scaffold frame 9 as indicated by dashed-two dotted line in FIG. 10 and FIG. 11. In this case, the lifeline 10 stretched between the rings 21 at the distal portions 12c of the support posts 12 can be located outside the vertical members 9a of the scaffold frames 9 to secure a large working space inside the lifeline 10. This is advantageous when large-sized materials are used, for example.

### Tilt of Support Post 12:

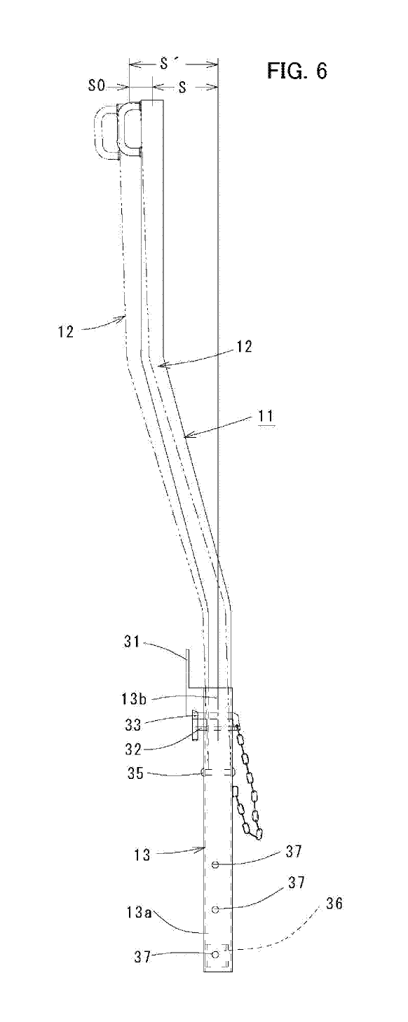

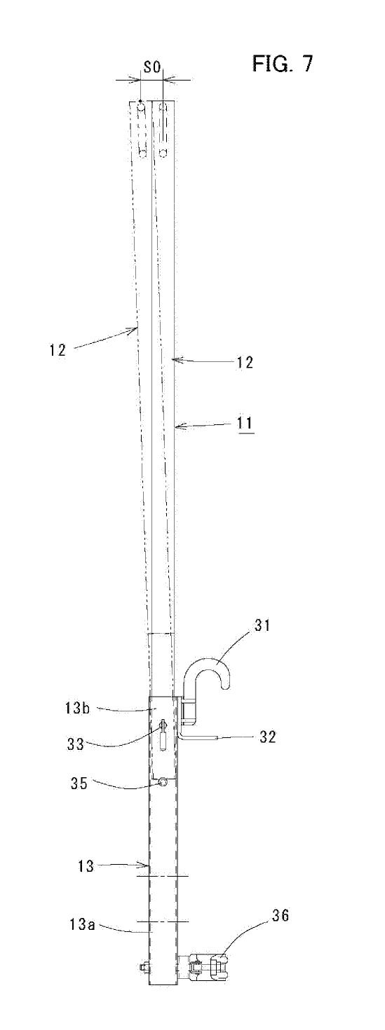

The support post 12 is attached to the tubular support post base 13 by fitting the proximal portion 12a of the support post 12 into the tubular support post base 13 in desired one of the four “position A” to “position D”. Then, the toggle pin 33 is inserted into the opposing first pin holes 34 and opposing second pin holes 22 (see FIG. 9) for preventing the support post 12 from coming off the tubular support post base 13. In this fitted state, gaps are inevitably formed between the inner surfaces of the tubular support post base 13 and the outer surfaces of the support post 12. The gaps cause the support post 12 to tilt with respect to the tubular support post base 13 as shown in FIG. 6 and FIG. 7. In the present invention, the tilt of the support posts 12 resulting inevitably from the coupling structure between the tubular support post bases 13 and the support posts 12 as described above is effectively used.

Namely, when the lifeline device R is applied to the reinforced type scaffold frames 9, the rings 21 at the distal portions 12c of the support posts 12 can be located inside the reinforcing members 9c of the scaffold frames 9 to avoid interference between the reinforcing members 9c and the lifeline 10. In this case, the necessary offset amount is achieved by utilizing not only the offset dimension of the support post 12 but also the displacement of the ring 21 resulting from the tilt of the support post 12. Specifically, as shown in FIG. 6, the sum of the offset dimension S of the support post 12 and the displacement S0 resulting from the tilt of the support post 12 can produce an offset amount S′ necessary to avoid the interference between the reinforcing members 9c and the lifeline 10.

Thus, to put it the other way around, the gaps between the tubular support post base 13 and the support post 12 are set, in other words, the dimensions of the tubular support post base 13 and the support post 12 are set, so that the tilt of the support post 12 can produce the displacement S0.

It should be noted that the support post 12 may be tilted to produce a displacement S0 even when the support post 12 is in the “position A” or “position D.” In this case, each tubular support post base 13 overlaps a vertical member 9a of the scaffold frame 9 when the scaffold frame 9 is viewed in a direction perpendicular to the horizontal arm 9b, so that the lifeline 10 stretched between the rings 21 at the distal portions 12c of the support posts 12 will interfere with the vertical members 9a if the displacement S0 is not produced. However, the displacement S0 resulting from the tilt of the support posts 12 as in this embodiment helps to prevent the interference between the lifeline 10 and the vertical members 9a. This is very advantageous.

### Specific Modes of Installation of Lifeline Device R:

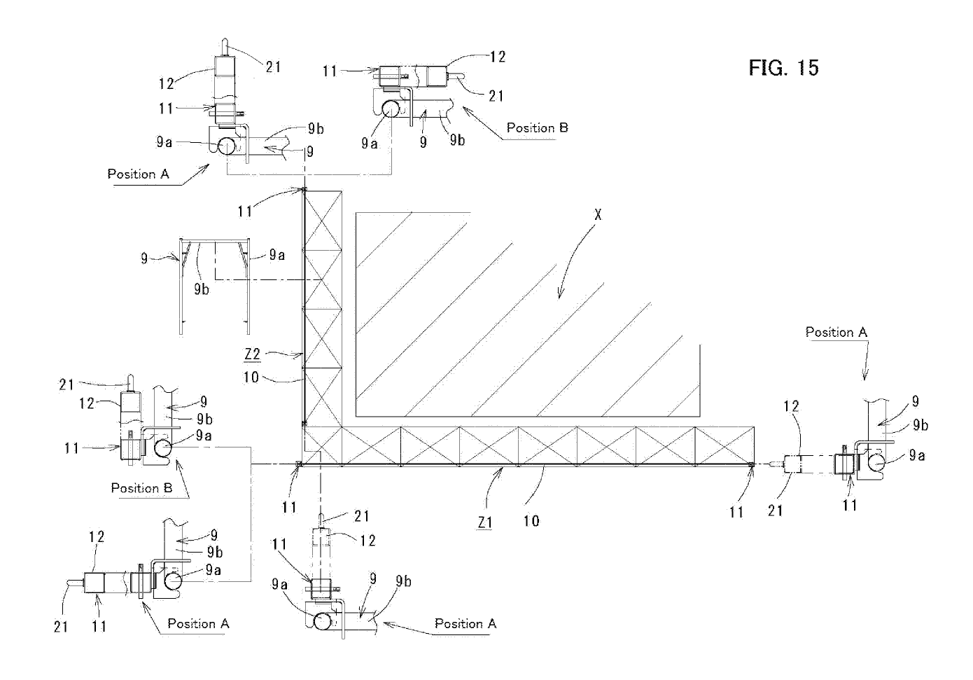

Specific installation modes of the lifeline device R will be next described with reference to FIG. 14 and FIG. 15. Reference shall be also made to FIG. 1 and FIG. 2 in which installation modes (positions A and B) of the lifeline support device R are schematically shown in enlarged views in “balloons”.

FIG. 14 (and also FIG. 1) schematically illustrates a mode of installation of the lifeline device R in a temporary scaffold Z constructed using reinforced type scaffold frames 9. The paired right and left lifeline support devices 11 installed in the temporary scaffold Z are both primarily used in the “position B.” In this mode of installation, the installed support posts 12 do not overlap the vertical members 9a of the scaffold frames 9 that are additionally provided on the existing scaffold unit U but are offset transversely therefrom. Thus, the lifeline 10 does not interfere with the vertical members 9a of the scaffold frames 9.

FIG. 15 schematically illustrates a mode of installation of the lifeline device R in a temporary scaffold Z constructed using simplified scaffold frames 9. The support post 12 of the right lifeline support device 11 of the paired right and left lifeline support devices 11 installed in the temporary scaffold Z is installed in the “position A.” Then, a hook 7 provided at one end of the lifeline 10 is fastened or linked to the ring 21 of the support post 12 as shown in FIG. 2 to fasten the lifeline 10 to the support post 12 via the hook 7.

The support post 12 of the left lifeline support device 11 of the paired right and left lifeline support devices 11 is installed in the “position A” or “position B” as needed.

When the left support post 12 is installed in the “position A,” the hook 7 at the other end of the lifeline 10 may be fastened to a part of the support post 12 inside the ring 21 to fasten the lifeline 10 to the support post 12 via the hook 7 as shown in FIG. 2. In this case, the support post 12 of the right lifeline support device 11 and the support post 12 of the left lifeline support device 11 are disposed approximately the same distance away from the building X. Thus, the lifeline 10 is stretched between the paired support posts 12 in parallel to the building line and is not oblique as viewed from above.

On the other hand, when the left support post 12 is installed in the “position B,” the hook 7 on the other end of the lifeline 10 is fastened to the ring 21 of the support post 12 to connect the lifeline 10 to the ring 21 via the hook 7. In this case, the support post 12 of the right lifeline support device 11 and the support post 12 of the left lifeline support device 11 are offset from each other in the transverse direction of the temporary scaffold Z by the distance corresponding to the offset amount of the left support post 12. Thus, the lifeline 10 stretched between the paired support posts 12 is slightly oblique as viewed from above. However, this does not cause any practical problem.

While only the “position A” and the “position B” of the four attachment positions are employed in the above embodiments, it is needless to say that the “position C” and/or the “position D” may be employed as needed.

### Installation of Lifeline Device R on Other Scaffold Systems:

While a prefabricated scaffold is described as an example of the temporary scaffold Z to which the lifeline device R is applied in the above embodiments, the present invention is not limited thereto but is also applicable to various types of temporary scaffolds Z. Examples of other scaffold systems will be briefly described below.

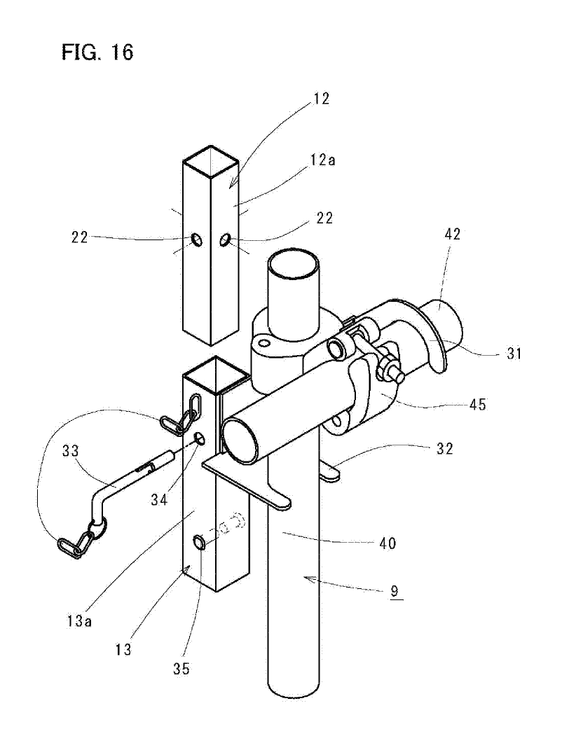

FIG. 16 illustrates a state where the lifeline device R is applied to a clamp binding type pipe scaffold. Reference numeral 40 designates a standard, which corresponds to the above “vertical member 9a.” Reference numeral 42 designates a brace, which corresponds to the above “horizontal arm 9b.” The standard 40 and brace 42 constitute a scaffold frame 9.

The hook 31 of the tubular support post base 13 of the lifeline support device 11 of this embodiment differs in shape and position from that of the above embodiments to avoid interference with a clamp member 45 coupling the standard 40 and the brace 42 and to cope with an increase in distance to the brace 42 because of the overlap between the standard 40 and the brace 42, so that the tubular support post base 13 of the lifeline support device 11 can be attached to the standard 40 and the brace 42. Other structural features are substantially the same as those of the above embodiments.

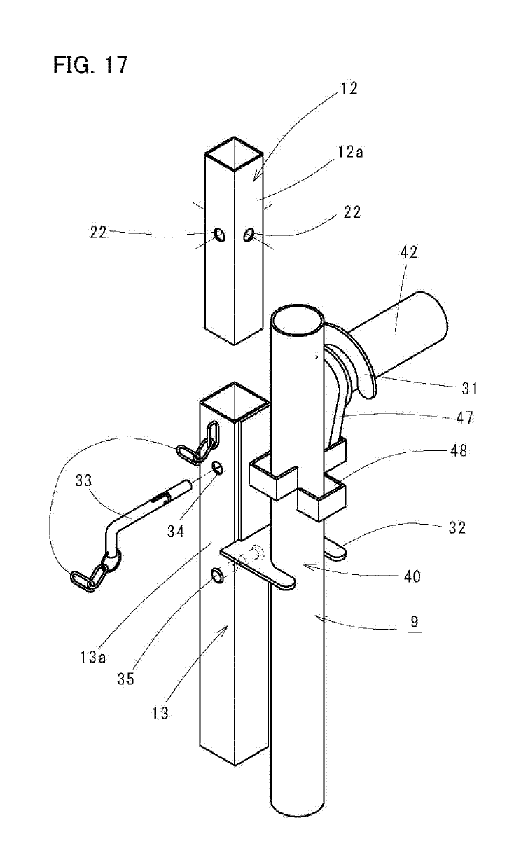

FIG. 17 illustrates a state where the lifeline device R is applied to a wedge binding type pipe scaffold. Reference numeral 40 designates a standard, which corresponds to the “vertical member 9a.” Reference numeral 42 designates a brace, which corresponds to the “horizontal arm 9b.” The standard 40 and brace 42 constitute a scaffold frame 9.

The hook 31 of the tubular support post base 13 of the lifeline support device 11 differs in shape and position from that of the above embodiment to avoid interference with a wedge 47 and a wedge receiver 48 used to join the standard 40 and the brace 42, so that the tubular support post base 13 of the lifeline support device 11 can be attached to the standard 40 and the brace 42. Other structural features are substantially the same as those of the above embodiments.

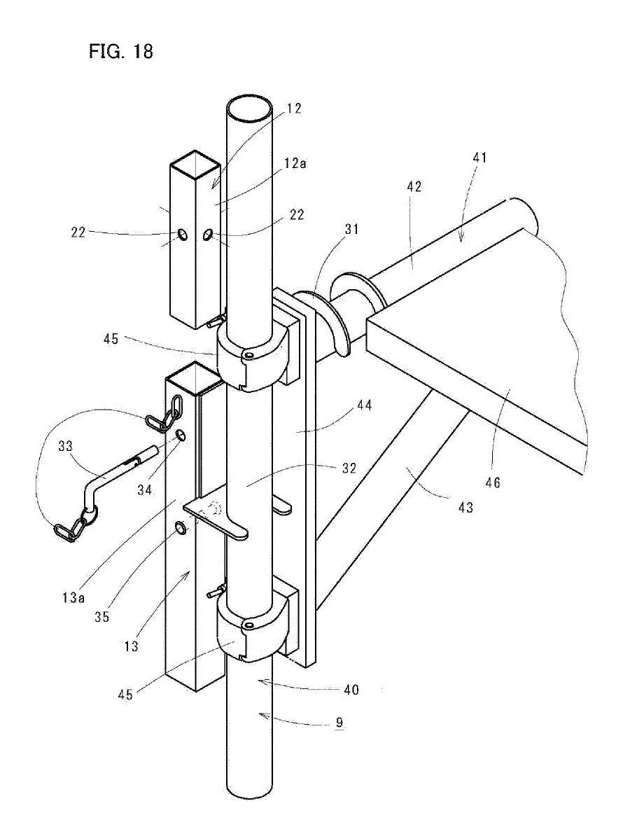

FIG. 18 illustrates a state where the lifeline device R is applied to a bracket scaffold. Reference numeral 40 designates a standard, which corresponds to the “vertical member 9a.” Reference numeral 42 designates a horizontal arm of a bracket 41, which corresponds to the “horizontal arm 9b.” The standard 40 and horizontal arm 42 constitute the “scaffold frame 9.” Reference numeral 43 indicates an auxiliary member provided between an attaching base member 44 and the horizontal arm 42 to provide them with rigidity, and reference numeral 46 indicates a scaffold board.

The hook 31 of the tubular support post base 13 of the lifeline support device 11 differs in shape and position from the hook 31 of the above embodiment to avoid interference with a clamp 45 clamping the standard 40 and the bracket 41 together and interference with the attaching base member 44 of the bracket 41, so that the tubular support post base 13 of the lifeline support device 11 can be attached to the standard 40 and the bracket 41. Other structural features are substantially the same as those of the above embodiments.

As having been described in the foregoing, the present invention provides a lifeline device R for use in a temporary scaffold Z constructed by stacking scaffold units U in multiple layers as needed, each of the scaffold units U being constructed by longitudinally arranging scaffold frames 9, each including a vertical member 9a and a horizontal arm 9b joined generally perpendicular to each other, at predetermined intervals and placing scaffold boards 3 between adjacent scaffold frames 9. The lifeline device R preferably comprises a pair of right and left lifeline support devices 11 and 11 each having a ring 21 at an upper end part thereof and respectively secured in an upright position to a pair of scaffold frames 9 of the temporary scaffold Z and spaced a predetermined distance away from each other, and a lifeline 10 that is stretched between the rings 21 and 21 of the paired lifeline support devices 11 and 11. The lifeline device R is characterized in that each lifeline support device 11 comprises a support post base 13 that is placed at a joint portion between the vertical member 9a and the horizontal arm 9b of a scaffold frame 9 from a direction generally perpendicular to the vertical member 9a and the horizontal arm 9b and held vertically and generally parallel to the vertical member 9a by a hook 31 that is hooked on the horizontal arm 9b from above, a pipe receiver 32 that is engaged with the vertical member 9a from a side thereof, and a clamp 36 that embraces the vertical member 9a, and a support post 12 having a proximal portion 12a that is inserted into the tubular support post base 13 and a distal portion 12c including the ring 21.

In the present invention, the tubular support post base 13 is fixed to a scaffold frame 9 by the hook 31 that is hooked on the horizontal arm 9b from above, the pipe receiver 32 that is engaged with the vertical member 9a from a side thereof, and the clamp 36 that embraces the vertical member 9a. Thus, because the clamp 36 can be fixed around the vertical member 9a with the tubular support post base 13 prevented from falling and inclining by the hook 31 and the pipe receiver 32, the tubular support post base 13 can be attached more easily, safely and appropriately.

More specifically, in the state where the hook 31 of support post base 13 is brought into engagement with the peripheral surface of the horizontal arm 9b, the tubular support post base 13 is prevented from falling. However, the tubular support post base 13 is allowed to slide in the direction parallel to the horizontal arm 9b (namely in the transverse direction) and is also allowed to swing about the horizontal arm 9b. Accordingly, once the hook 31 of support post base 13 has been hooked over the horizontal arm 9b, it is easy to displace the tubular support post base 13 toward the vertical member of the scaffold frame 9 and to urge the pipe receiver 32 of the tubular support post base 13 to engage the vertical member 9a of the scaffold frame. When the pipe receiver 32 of the tubular support post base 13 has been subsequently brought into engagement with the vertical member 9a, no further transverse movement is possible. Additionally, the tubular support post base 13 is no longer swingable about the horizontal arm 9b. At this state, the tubular support post base 13 is held upright and in parallel to the vertical member 9a of the scaffold frame. Therefore, the subsequent work for clamping of the tubular support post base 13 to the vertical member 9a with the clamp 36 becomes very easy and safe.

In addition, the tubular support post base 13 is placed at a joint between the vertical member 9a and the horizontal arm 9b of a scaffold frame 9 from a direction generally perpendicular to the vertical member 9a and the horizontal arm 9b. Thus, the workers can carried out the work without hanging their bodies outward over the scaffold frame 9. Thus, the safety of the work is ensured compared to a case where the workers have to hang their bodies outward over a scaffold frame 9 because the support post base 13 needs to be attached to a scaffold frame 9 from outside, for example.

The lifeline device for a temporary scaffold according to the present invention may be used as an effective safety measure to prevent falling accidents of a worker who works in high places such as on a temporary scaffold in a construction site. The safety is attained by stretching a lifeline tight on the opposite side of the building above the scaffold boards, and having each worker fasten a lanyard or life strap connected to his or her harness or waist belt to the lifeline.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

What is claimed is:

1. A lifeline support device for being mounted on a scaffold frame having a vertical member and a horizontal arm connected to the vertical member, said lifeline support device comprising:
a tubular support post base having an upper portion provided with a hook engageable over the horizontal arm from above and a pipe receiver engageable with the vertical member, such that, when the hook is engaged with the horizontal arm with the pipe receiver engaged with the vertical member, the tubular support post base is held generally parallel to the vertical member,
a clamp detachably mounted to a lower portion of the tubular support post base for clamping the tubular support post base to the vertical member, and
a support post having a proximal portion fittable into and securable in the tubular support post base and a distal portion provided with a ring for receiving a lifeline.

2. The lifeline support device as recited in claim 1, wherein the proximal portion has an axis that is offset from that of the distal portion so that the orientation of the support post can be changed about an axis of the tubular support post base.

3. The lifeline support device as recited in claim 1, wherein each of the tubular support post base and the support post of the lifeline support device is formed of a square pipe having two pairs of opposing sides so that the support post is securable in the tubular support post base in four different orientations relative to the tubular support post base.

4. The lifeline support device as recited in claim 3, wherein one of the two pairs of the opposing sides that constitute the tubular support post base each have a first pin hole, while each of the four sides that constitute the support post has a second pin hole, said first and second pin holes are located so that when the support post is secured in the tubular support post base, a pin is insertible through the two first pin holes and two second pin holes at the same time, and wherein said pin is secured to the tubular support post base by means of a flexible connecting member.

5. A lifeline device for use in a temporary scaffold constructed by stacking scaffold units in multiple layers, each of the scaffold units being constructed by longitudinally arranging a plurality of inverted U-shaped scaffold frames at predetermined intervals and placing scaffold boards between adjacent scaffold frames, each of the scaffold frames including a pair of spaced apart vertical members and a horizontal cross arm between upper ends of the vertical members, said lifeline device comprising:
a pair of right and left lifeline support devices according to claim 1,
a lifeline that is configured to be linked to the rings of the paired lifeline support devices, and
a lifeline tensioner that is connectable to the lifeline so that the lifeline, when linked to rings of the paired lifeline support devices mounted on the scaffold unit with a predetermined distance, is maintained in a tightly stretched condition between the paired lifeline support devices.
